(19) United States
(12) Patent Application Publication
(10) Pub. No.: US 2010/0077589 A1
(43) Pub. Date: Apr. 1, 2010

(54) Apparatus and method for manufacturing or repairing a circuit board

(75) Inventors: Timothy Lang, Waterloo (CA); David Phillips, Waterloo (CA); Andrew Hammond, Waterloo (CA); Justin Kaufman, Thornhill (CA)

Correspondence Address: OGILVY RENAULT LLP, 1, Place Ville Marie, SUITE 2500, MONTREAL, QC, H3B 1R1, CA

(73) Assignee: RESEARCH IN MOTION LIMITED, Waterloo (CA)

(21) Appl. No.: 12/461,793

(22) Filed: Aug. 25, 2009

Related U.S. Application Data
(60) Provisional application No. 61/092,894, filed on Aug. 29, 2008.

(51) Int. Cl. B23P 19/00

(52) U.S. Cl. 29/426.1; 29/762

(57) ABSTRACT

A method for uncoupling an interference shield from a circuit board is provided. The method includes providing a circuit board including a surface mounted component and an interference shield configured to provide shielding of the surface mounted component. The interference shield is coupled to the circuit board by a joint. Heating of the joint is effected by induction heating such that the interference shield becomes configured for displacement relative to the circuit board in response to application of a mechanical force. An apparatus for effecting the uncoupling is also provided.

### TECHNICAL FIELD

This subject matter relates to manufacturing and repairing circuit boards.

### BACKGROUND

Radio frequency (“RF”) shields or cans typically need to be removed as a result of the “printed circuit board assembly” (PCBA) failing test. A failed test would be an indicator that there is something wrong with the components on the board. A debug technician would use various tools at their disposal to try to determine the cause of the problem. At times the debug technician may need to use X-ray to “see” under a can or they may request the can be removed. Regardless of how a debug technician determines the root cause of the problem a can would need to be removed to access a component that would need to be replaced under said can. In many cases in the cell phone industry over 90% of components on a PCB would be covered by cans.

Current methods used in the micro-electronics industry for removing interference shields are automated convection (hot air reflow by machine), manual convection (hot air applied by a hand held wand) and soldering iron (contact reflow).

Automated convection can be effected using a ball grid array rework equipment. The premise of the ball grid array rework equipment is to utilize a controlled heat cycle or ‘reflow profile’ to remove the can or any other component from the substrate that it is electrically and mechanically bonded to by means of solder.

The equipment uses a stream of hot air which has programmable temperature, time and air-flow to facilitate an effective reflow profile. The board or substrate for rework would be put in a work nest on the table of the ball grid array rework equipment; under the board or substrate is a pre-heat matrix which applies a steady heat to the board, an infrared sensor above the work nest monitors the board temperature and once a pre-defined, programmed temperature level has been reached the remaining process is initialized. Once the pre-heat temperature has been reached, a z-axis containing the air nozzle is lowered and ‘presented’ to the board—the stand off height of the z-tool is also pre-determined by program. Once in position, the z-tool will start the airflow and direct airflow through the nozzle to the target area—heat is subsequently applied to the target area by means of convection, the target area heats up in accordance with the programmed reflow profile until the target area of solder becomes liquidous—at this liquidous stage the can is able to release from the substrate—the component is then picked up from the substrate via a vacuum tip as the z-axis rises to its ‘home’ position, such that the can has been removed from the substrate.

The method of can removal using automated convection or manual convection rework stations poses many problems and inefficiencies:
1) Time required—The total cycle time that is required to remove a relatively large can from start to finish can vary between 5-10 minutes.
2) Undesired stress and damage—Using conventional automated convection machines, heat is delivered to the board in the general vicinity of the can or component being reworked. Heat is delivered to the plastic components which often damage them to the point where they need to be replaced.
3) Solder Ball formation—Presently the manufacturing process of PCBs involves the application of an epoxy underfill material that is injected through holes in the surface of a can; the underfill is deposited such that it flows underneath the various components to be strengthened. However once the need arises to rework a component within the premises of an underfilled can difficulties arise. When conventional heat is applied through a convective process solder balls form because of the different expansion co-efficients of the underfill and solder. The solder balls can pose a quality risk as they can break off and cause electrical shorts between components that would be otherwise be isolated.

### BRIEF DESCRIPTION OF DRAWINGS

FIG. 1 is a schematic illustration of an embodiment of an apparatus for effecting the manufacture or repair of a circuit board, wherein the displacer is disposed in an operative condition and the interference shield is coupled to the board component of the circuit board;

FIG. 2 is a schematic illustration, in elevation, of the apparatus in FIG. 1, wherein the displacer is in an other than operative condition and retracted from the circuit board;

FIG. 3 is plan view of the circuit board support of the apparatus illustrated in FIGS. 1 and 2; and

FIG. 4 is a detailed perspective view of a portion of the heating and displacing unit of the apparatus illustrated in FIGS. 1 and 2;

FIG. 5 is a schematic illustration of another embodiment of an apparatus for effecting the manufacture or repair of a circuit board, showing the displacer in an other than operative condition and retracted from the circuit board;

FIG. 6 is a schematic illustration of the apparatus illustrated in FIG. 5, showing the displacer having become disposed in the operative condition, with the interference shield still coupled to the board component of the circuit board, and a piston, which has effected movement of the displacer from the retracted position to a ready position, from which the displacer subsequently becomes coupled to the interference shield by a coupling action, having not yet been retracted from the circuit board support;

FIG. 7 is a schematic illustration of the apparatus illustrated in FIG. 5, showing the piston having become retracted from its position in FIG. 6; and

FIG. 8 is a schematic illustration of the apparatus illustrated in FIG. 5, showing the displacer, coupled to the interference shield, having become retracted from the circuit board support, and thereby effecting separation of the interference shield from the circuit board.

### DETAILED DESCRIPTION

### 1. Process of Manufacturing a Printed Circuit Board Assembly

The following is a description of exemplary embodiments of a process of manufacturing a printed circuit board (“PCB”) assembly. For example, the PCB is included in a portable electronic device. The portable electronic device may be a two-way communication device with advanced data communication capabilities including the capability to communicate with other portable electronic devices or computer systems through a network of transceiver stations. The portable electronic device may also have the capability to allow voice communication. Depending on the functionality provided by the portable electronic device, it may be referred to as a data messaging device, a two-way pager, a cellular telephone with data messaging capabilities, a wireless Internet appliance, or a data communication device (with or without telephony capabilities). The portable electronic device may also be a portable device without wireless communication capabilities as a handheld electronic game device, digital photograph album, digital camera and the like.

A manufacturing process for manufacturing a printed circuit board assembly (PCBA) includes three (3) main steps: 1) the application of solder paste to specific locations, called pads, on the printed circuit board (PCB); 2) placement of the components or “surface mount device” (SMD's) on the solder paste deposits; and 3) reflow, which is a slow regulated increase in temperature to the point where solder paste melts, followed by a regulated cool down period, so that it can form the final electrical and mechanical connection between the SMD's and the PCB.

There are many different kinds of solder paste made up of various specially blended metals combined with a flux medium. Solder paste is deposited on a PCB via a process known as “solder paste printing”.

Solder paste, which serves as the mechanical and electrical attachment medium between the components and the PCB itself, is deposited on the pads of the PCB. The components are then accurately positioned over the deposited solder paste via placement machines. The PCB then proceeds through a reflow oven where the solder paste is then melted (or reflowed) at a high temperature to effect the soldering of the devices to the PCB with a well-formed, contiguous fillet. After this solder reflow, the solder is allowed to cool down again to solidify and attain the mechanical properties necessary to keep the components firmly mounted on the PCB.

### Solder Paste Printing:

Two major processes for printing solder paste onto PCB's include mesh screen stencil printing and metal stencil printing. Metal stencil printing is commonly used in the cell phone industry today.

In both methods, squeegees are generally used to roll the solder paste evenly across the stencil. By properly rolling the solder over the stencil, the solder paste passes through the stencil apertures and gets deposited on designated areas of the PCB. The stencil is then lifted, or the PCB is lowered, leaving behind the intended solder paste pattern on the PCB.

There are many different companies that manufacture screen printing systems that offer many options—computer control, vision or laser print control, environment control, automatic PCB support set-up, and even stencil cleaning.

### Placement of SMD's:

The boards then proceed to pick-and-place machines via a series of conveyors. Small SMD's or components are usually delivered to the production line on paper or plastic tapes wound on reels. Pick-and-place machines remove the parts from the reels and place them on the PCB.

### Solder Reflow:

Solder reflow is accomplished using equipment known as a solder reflow oven. Reflow ovens typically employ either “infrared (IR) reflow” or “convection reflow” to expose the PCB and associated components to the necessary temperature profile.

IR reflow is achieved with the use of infrared lamps which transfer thermal energy to the board assembly. The board assembly is heated by IR reflow primarily by line-of-sight surface heat absorption. Because of this, variations in the density of the board can result in ‘hot spots’ (or localized areas with significantly higher temperatures) on the board during IR reflow. As such, some components experience higher stress levels than others on the board even if they are subjected to the same IR reflow conditions.

Convection reflow transfers heat to the board assembly by blowing heated air around it. Convection reflow provides a more uniform heat distribution to the circuit assembly compared to IR reflow and is not as prone to hot spots and component stress.

A solder reflow process follows an optimized temperature profile to prevent the board from experiencing unrealistically high thermal stresses while it is undergoing reflow. The optimized temperature profile depends on the type of solder paste being used, the structure of the PCB and the components being used. A typical reflow temperature profile would consist of the following steps or stages:
1) “Preheat”, which gradually ramps up the temperature to the preheat zone temperature at which the solvents will be evaporated from the solder paste.
2) “Flux Activation”, which brings the dehydrated solder paste to a temperature at which it is chemically activated, allowing it to react with and remove surface oxides and contaminants;
3) “Actual Reflow”, which consists of ramping up the temperature to the point at which the solder alloy content of the solder paste melts, causing the solder to sufficiently wet the interconnection surfaces of both the SMD's and the PCB and form the required solder fillet between the two. The peak reflow temperature should be significantly higher than the solder alloy's melting point to ensure good wetting, but not so high that damage to the components is caused.
4) “Cooldown”, which consists of ramping down the temperature at optimum speed (fast enough to form small grains that lead to higher fatigue resistance, but slow enough to prevent thermo-mechanical damage to the components) until the solder becomes solid again, forming good metallurgical bonds between the components and the board.

### Underfill:

In some cases, it may be desirable to underfill certain SMD's on a PCBA. Underfill is an epoxy type adhesive which is flowed under and around the SMD and cured. The adhesive is “pulled” under the device by capillary action.

Underfill is utilized in the electronics manufacturing industry for at least one of a few reasons. A first is related to field reliability. Underfill will provide the final product with higher resistance to customer abuse in the field. A second reason is the underfilled component is more difficult to remove from the circuit board without damaging it, making it extremely difficult to “hack-in” to the final product.

For example, the manufacturing process of a PCB assembly involves the application of an epoxy underfill material that is injected through holes in the surface of a can that has already gone through the reflow cycle as outlined above. For example, the underfill is injected into the can or interference shield (see below) via an automated process using a dispensing system. The underfill is then cured through the use of a reflow oven at much lower temperatures than those used to reflow solder paste. Once cured the underfill provides the desired strength.

### Solder:

Solder is a low melting point alloy used in numerous joining applications in microelectronics. Solder is typically classified as either lead-tin or lead free alloys. Typical lead-tin solder contains 60% tin and 40% lead—increasing the proportion of lead results in a softer solder with a lower melting point, while decreasing the proportion of lead results in a harder solder with a higher melting point. Typical lead-free solders contain silver, tin and copper. Both types of solder contain elements of flux and volatile materials to aid cleansing and coalescence of the target joint for bonding. Lead free solders are now widely used in accordance with European and global legislation (restriction of hazardous substances) restricting the use of lead and certain other chemicals in electronics.

### Interference Shield or “Can”:

The “can” is usually formed from cold rolled steel. If there are non-ferrous requirements, nickel-silver alloys can be used. For example a typical manufacturing process could utilize either a folding or drawn process to form the cans. The primary reason for using cans is for radio frequency (i.e. RF) shielding. The cans vary in shape depending on the circuitry they are designed to protect and isolate from the outside environment.

### 2. Method for Uncoupling Interference Shield

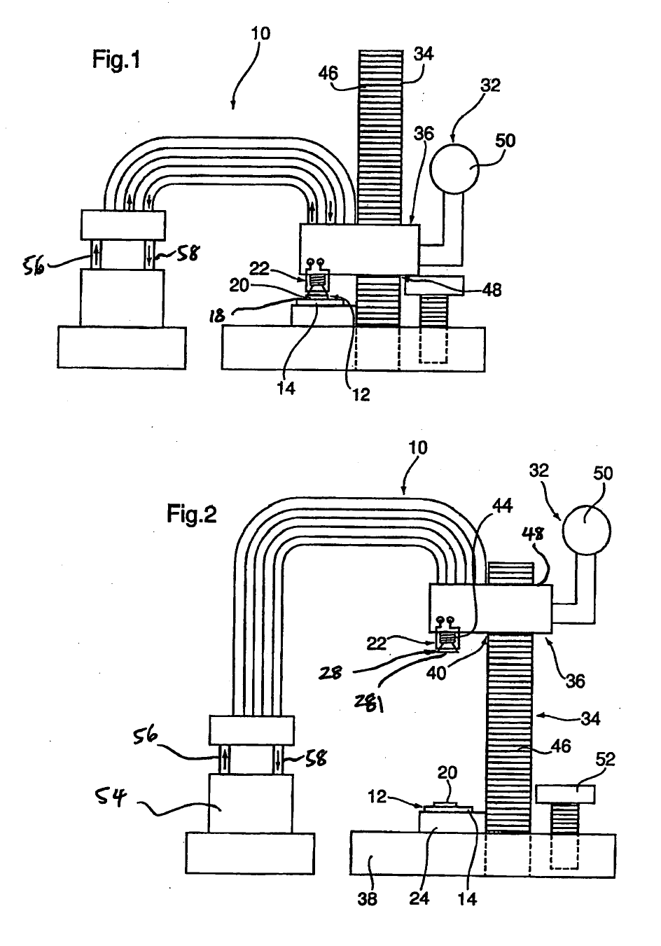

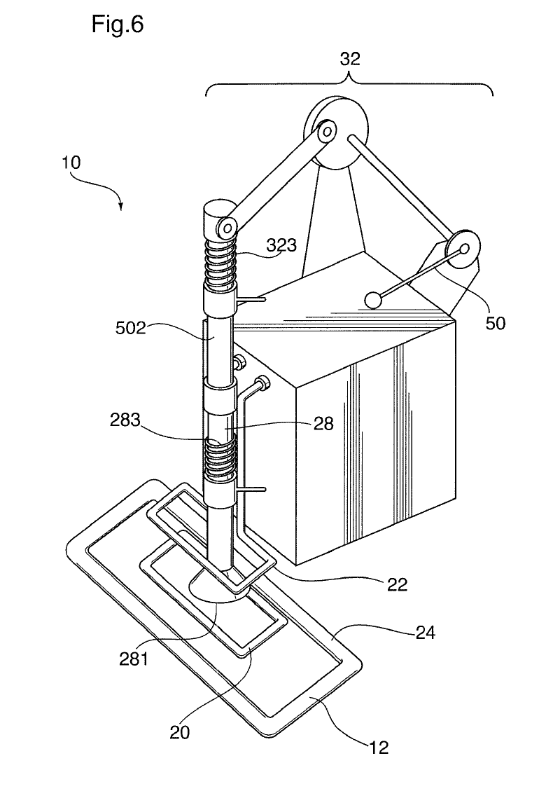

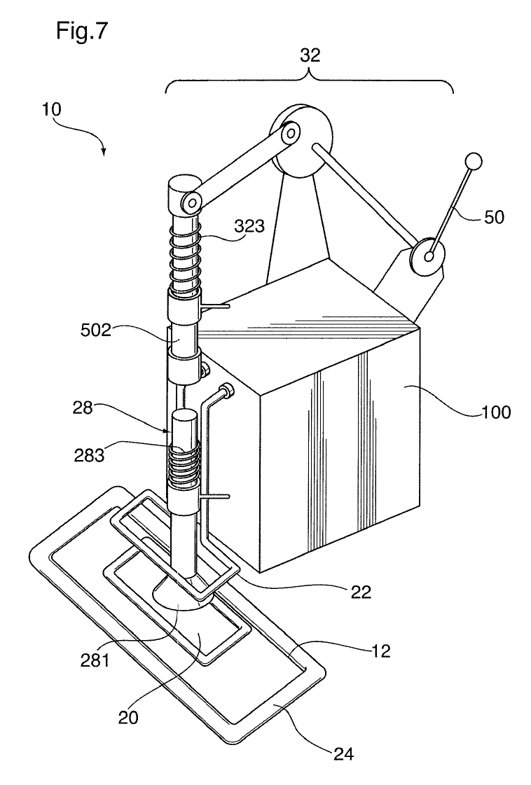

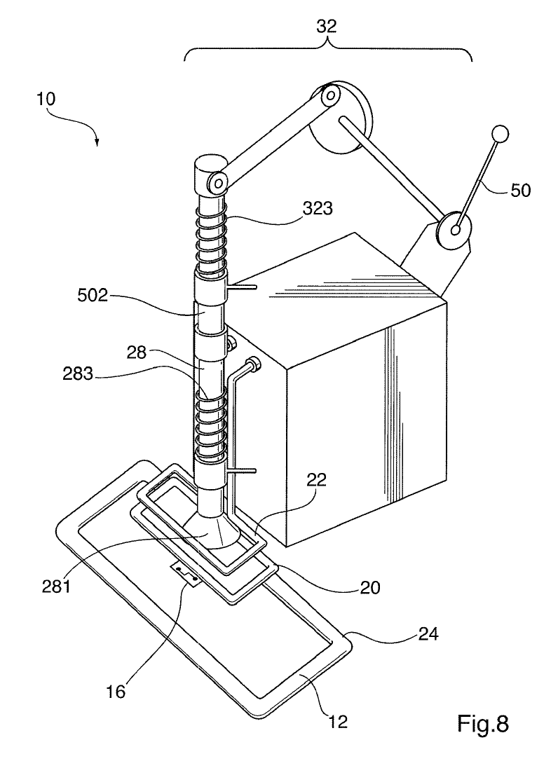

Referring to FIGS. 1 and 2, in accordance with one aspect, there is provided a method for uncoupling an interference shield 20 from a board component 14 of a circuit board 12. A circuit board 12 is provided, and the circuit board 12 includes a board component 14, a surface mounted component 16 coupled to the board component 14, and an interference shield 20 coupled to the board component 14 with a joint 18, wherein the interference shield 20 is configured to provide shielding of the surface mounted component 16 (shown in the embodiment illustrated in FIGS. 5 to 8). Heating of the joint 18 is then effected by induction heating such that the interference shield 20 becomes configured for displacement relative to the board component 14 in response to application of a mechanical force. In some embodiments, the joint 18 includes a relatively lower temperature condition and a relatively higher temperature condition, wherein, while the joint 18 is disposed in the relatively higher temperature condition effected by heating of the joint 18, wherein the heating of the joint 18 is effected by induction heating, the minimum mechanical force necessary to effect displacement of the interference shield 20 relative to the board component 14 is less than the minimum mechanical force necessary to effect displacement or separation of the interference shield 20 relative to the board component 14 while the joint 18 is disposed in the relatively lower temperature condition. In some embodiments, induction heating effects heating of the joint 18 such that the joint 18 condition changes from a relatively lower temperature condition to a relatively higher temperature condition. In some embodiments, while the joint 18 is disposed in the relatively higher temperature condition effected by heating of the joint 18, wherein the heating of the joint 18 is effected by induction heating, displacement or separation of the interference shield 20 relative to the board component 14 is effected, such as by a mechanical force.

In some embodiments, the joint is created from solder. In this respect, for example, a solder paste compound is applied to a predetermined location on the board component 14, and is then heated to a liquidous temperature. While the solder paste is still in liquidous form, the interference shield is set into the liquidous form of the solder. Cooling of the liquidous form of the solder is then permitted or effected to create a mechanically robust joint between the interference shield 20 and the board component 14.

For example, the surface mounted component can be any one of the following: Capacitors, resistors, transistors, filters, and ball grid array.

With respect to the “shielding” provided by the interference shield 20, for example, the interference shield 20 provides any one or any combination of the following shielding functions: electromagnetic interference shielding, shielding from external environment (for example, moisture), or deterring from intrusion. In some embodiments, the interference shield 20 also provides mechanical strengthening functionality.

In some embodiments, in accordance with any one of the above-described methods, any one of the methods further comprises effecting displacement of the interference shield 20 relative to the board component 14 so as to facilitate replacement of the surface mounted component 16. In some embodiments, the displacement includes removal of the interference shield 20 from the board component 14.

### 3. Apparatus for Uncoupling Interference Shield

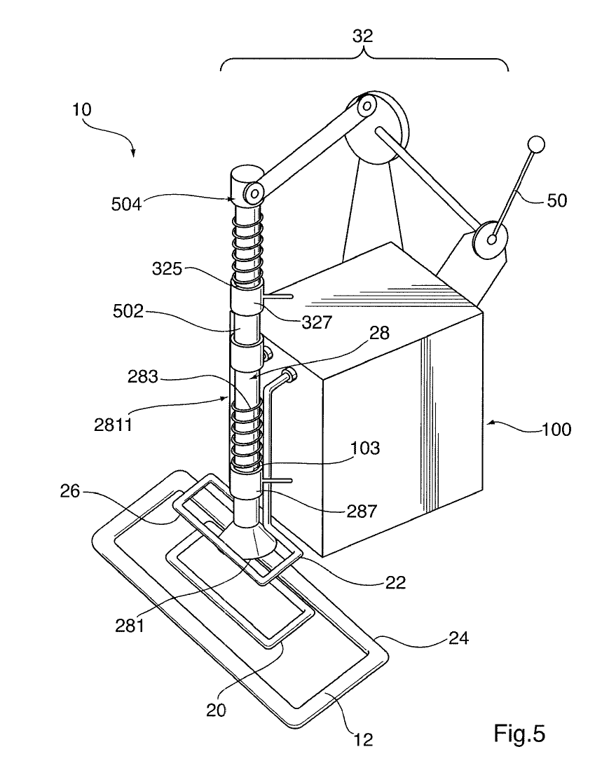

Referring to FIGS. 1 to 8, in accordance with a further aspect, there is provided an apparatus 10 for uncoupling an interference shield 20 from a shielded component assembly 12 supported on a support 24. The apparatus 10 includes a displacing unit.

The support 24 is configured for supporting a shielded component assembly 12. The shielded component assembly 12 includes a component support base 14, a surface mounted component 16 and the interference shield 20. The surface mounted component 16 is coupled to a surface of the component support base 14. The interference shield 20 is coupled to the component support base14 at a joint 18 such that the surface mounted component 16 is at least partially shielded by the interference shield 20. For example, the interference shield 20 effects at least partial shielding of the surface mounted component 16 from electromagnetic radiation, such as a radio waves. In this respect, the interference shield 20 is configured to provide shielding of the surface mounted component 16 from radio frequency radiation. The interference shield 20 provides any combination of the following shielding functions: electromagnetic interference shielding, shielding from external environment (for example, moisture) or deterring from intrusion. In some embodiments, the interference shield also provides mechanical strengthening functionality.

The displacing unit 36 includes a displacer 28.

The displacer 28 is configured for releasably coupling to the interference shield 20. For example, the displacer 28 includes a vacuum-assisted suction cup 281. The displacer 28 is moveable relative to the support 24.

When the joint 18 is disposed in a relatively higher temperature condition and the displacer 28 is coupled to the interference shield 20 of the shielded component assembly supported on the support 24, the displacer 28 is moveable relative to the support so as to effect retraction of the displacer 28 relative to the support 24 and thereby effect separation of the interference shield 20 from the base 14. In this respect, the force applied to the displacer 28 to effect the retraction is sufficient to overcome any forces which couple the interference shield 20 to the base 14 at the joint 18.

In some embodiments, the above-described retraction of the displacer 28 relative to the support 24 is effected by a biasing force. In this respect, in some embodiments, when the displacer 28 is coupled to the interference shield 20 and the shielded component assembly 12 is supported on the support 24, the displacer is biased to retract from the support 24. When the joint 18 is disposed in a relatively higher temperature condition and the displacer 28 is coupled to the interference shield 20 of the shielded component assembly 12 supported on the support 24, the biasing of the displacer 281 effects retraction of the displacer 28 relative to the support 24 and thereby effects separation of the interference shield 20 from the base 14. For example, when the joint 18 is disposed in the relatively lower temperature condition and the displacer 28 is coupled to the interference shield 20 of the shielded component assembly 12 supported on the support 24, and the joint 18 is heated to, or above, the relatively higher temperature condition, the biasing of the displacer 28 effects retraction of the displacer 28 relative to the support 24 and thereby effects separation of the interference shield 20 from the base 14.

In some embodiments, the apparatus 10 includes a frame 100, and the frame 100 includes a biasing member retainer 103, and the apparatus further includes a biasing member 283 which is retained between the biasing member retainer 103 and the displacer 28. When the displacer 28 is coupled to the interference shield 20 and the shielded component assembly 12 is supported on the support 24, the biasing member 283 biases the displacer 28 to retract from the support 24. In some embodiments, the biasing member 283 includes a resilient member 283, such as a coil spring 283.

In some embodiments, the above-described movement of the displacer 28 to the retracted position is effected by an actuator 32, such that the displacing unit 28 includes the actuator 32 and the displacer 28, wherein the actuator 32 is coupled to the displacer 28.

In some embodiments, and referring to FIGS. 1 to 4, the actuator includes a rack 46, a corresponding pinion 48, and a manual pull lever 50. The pinion 48 is responsive to actuation of the lever 50. The pinion 48 is moveable relative to the rack 46, and the movement of the pinion 48 relative to the rack 46 is effected by the actuation of the lever 50. The displacer 28 is coupled to the pinion 48 and is, thereby, responsive to the actuation of the lever 50. In this respect, the displacer 28 is also moveable relative to the rack 46. The rack 46 defines a vertical axis parallel to which the pinion 48 is configured to move upon actuation of the lever 50, and the position of the pinion 48 is dependent on the position of the manual pull lever 50. Actuation of the manual pull lever 50 effects application of force to the displacer 28, and effects a response by the displacer 28. The response includes movement of the displacer 28, relative to the circuit board support 24, by virtue of indexed movement of the pinion 48 along an extent of the rack 46. In this respect, the displacer 28 is retractable relative to the support 24, in response to indexed movement of the pinion 48 along an extent of the rack 46. When the joint 18 is disposed in a relatively higher temperature condition and the displacer 28 is coupled to the interference shield 20 of the shielded component assembly 12 supported on the support 24, the displacer 28 is moveable to a retracted position relative to the support 24 (i.e. is retractable from the support 24) by actuation of the lever 50.

In some embodiments, the displacer 28 is coupled to the pinion 48 by a resilient member 283. In this respect, when the joint 18 is disposed in the relatively lower temperature condition and the displacer 28 is coupled to the interference shield 20 of the shielded component assembly 12 supported on the support 24, tensioning of the resilient member 283 is effected by actuation of the lever 50 in a reverse direction, as the force being applied by the resilient member 283 to the displacer 28, is opposed by the force which effects the coupling of the displacer 28 to the interference shield 20. After heating, when the joint 18 becomes disposed in the relatively higher temperature condition, the force being applied by the tensioned resilient member 283 to the displacer 28 overcomes any force which effects the coupling of the displacer 28 to the interference shield 20, to thereby effect retraction of the displacer 28 from the support 24 and thereby effect separation of the interference shield 20 from the base 14.

In some embodiments, the displacer 28 is disposed in an other than operating condition, and moveable towards the support 24, and any shielded component assembly 12 supported on the support 24, in conjunction with indexed movement of the pinion 48 along an extent of the rack 46. In this respect, when the joint 18 is disposed in the relatively lower temperature condition and the shielded component assembly 12 is supported on the support 24, and the displacer 28 is retracted from the supported shielded component assembly 12, in response to an actuation force applied to the lever 50, the displacer 28 is moveable from the retracted position to a ready position relative to the support shielded component assembly 12. In the ready position, the displacer 28 is positioned for coupling to the interference shield 20 of the shielded component assembly 12 in response to a coupling action.

Referring to FIGS. 5 to 8, in some embodiments, the actuator 32 is crank system and includes a lever 50, suitably mounted to a frame 100, and a piston 502, the piston 502 is responsive to an actuation force applied to the lever 50 to effect movement of the other than operative condition-disposed displacer 28 towards a shielded component assembly 12 supported on the support 24 for effecting coupling of the displacer 28 to the interference shield 20 of the shielded component assembly 12. In this respect, when the joint 18 is disposed in the relatively lower temperature condition and the shielded component assembly 12 is supported on the support 24, and the displacer 28 is retracted from the supported shielded component assembly 12 in the other than operative condition, in response to an actuation force applied to the lever 50, the displacer 28 is moveable by the piston 502 from the retracted position to a ready position relative to the supported shielded component assembly 12. In the ready position, the displacer 28 is positioned for coupling to the interference shield 20 in response to a coupling action. In some embodiments, the piston 502 is biased away from the support 24 by a biasing force, and the movement of the displacer 28, effected by the piston 502, is opposed by the biasing force. In some embodiments, the biasing force applied to the piston 502 is exerted by a biasing member 323, such as a resilient member 323 (for example, a coil spring) against the piston 502. In some embodiments, the apparatus 10 further includes a biasing member retainer 325, mounted to the frame 100, which co-operates with a retainer surface 504 provided on the piston 502 to provide mounting surfaces for the biasing member 323. For example, the biasing member retainer 325 also functions as a guide 327 for facilitating guided movement of the piston 502 as the piston 502 is actuated by the lever 50 to effect the movement of the displacer 28. In some embodiments, the movement of the displacer 28 by the piston 502 is effected by contact engagement of the piston 502 with the displacer 28. After the displacer 28 has become coupled with the interference shield 20, the piston 502 is retracted by the lever 50 from the displacer 28, so as to provide space for the retraction of the displacer 28. In some embodiments, upon removal of the force being applied to the lever 50, the retraction of the piston 502 is effected by the above-described biasing force being applied to the piston 502 (for example, the biasing force exerted by the biasing member 323). The retraction of the displacer 28 relative to the support 24 is effected by a biasing force, such as that exerted by the biasing member 283. This biasing force also opposes the movement of the displacer 28 by the piston 502. After the piston 502 has been retracted from the displacer 28, when the joint 18 is disposed in a relatively higher temperature condition and the displacer 28 is coupled to the interference shield 20 of the shielded component assembly 12 supported on the support 24, the biasing of the displacer 28 effects retraction of the displacer 28 relative to the support 24 and thereby effects separation of the interference shield 20 from the base 14. For example, after the piston 502 has been retracted from the displacer 28, when the joint 18 is disposed in the relatively lower temperature condition and the displacer 28 is coupled to the interference shield 20 of the shielded component assembly 12 supported on the support 24, upon the joint 18 being heated to, or above, the relatively higher temperature condition (for example, by the induction heater 22), the biasing of the displacer 28 effects retraction of the displacer 28 relative to the support 24 and thereby effects separation of the interference shield 20 from the base 14. The frame 100 also includes the biasing member retainer 103 which co-operates with a retainer surface 2811 provided on the displacer 28 to provide mounting surfaces for the biasing member 283. For example, the biasing member retainer 103 also functions as a guide 287 for facilitating guided movement of the displacer 28 while the displacer 28 is being moved by the piston 502, as well as while the displacer 28 is being retracted from the support 24.

In some embodiments, the coupling action includes pressing of a provided suction cup 281 against the interference shield 20.

In some embodiments, the coupling action includes generation of a vacuum between the displacer 28 and the interference shield 20. In this respect, for example, a vacuum generator (not shown) is provided to effect generation of a vacuum between the displacer 28 and the interference shield 20 such that, when the displacer 28 is within sufficient proximity of the interference shield 20, the generated vacuum effects coupling of the displacer 28 to the interference shield 20. For example, the vacuum is generated between the displacer 28 and the interference shield 20 by effecting fluid communication between the vacuum generator and the interference shield 20 through a passage provided within the displacer 28.

In some embodiments, a weighted support base 38 is provided to effect support of the displacer 36 and the support 24. In some embodiments, an adjustable end stop 52 is provided so as to limit downwardly movement of the displacer 28.

In some embodiments, the displacing unit 36 is a heating and displacing unit 36, and, in this respect, includes the heater 22. The heater 22 is configured for effecting heating of the joint 18 such that the joint 18 becomes disposed in the relatively high temperature condition. For example, the heater 22 includes an induction heater 22. The induction heater 22 is configured to effect generation of a magnetic field so as to effect induction heating of the joint 18. For example, the induction heater 22 includes an induction heating coil 26 configured to generate the magnetic field. The induction heater 22 is powered by any generic induction power supply, and upon powering of the induction heater 22 by the power supply, the induction heater 22 is disposed in the operative condition.

In some embodiments, the support 24 is a circuit board support 24, the shielded component assembly 12 is a circuit board 12, and the component support base 14 is a board component 14. The circuit board support 24 is configured for supporting the circuit board 12. The interference shield 20 is configured to provide shielding of the surface mounted component 16. Exemplary surface mounted components 16 include capacitors, resistors, transistors, filters, and ball grid arrays.

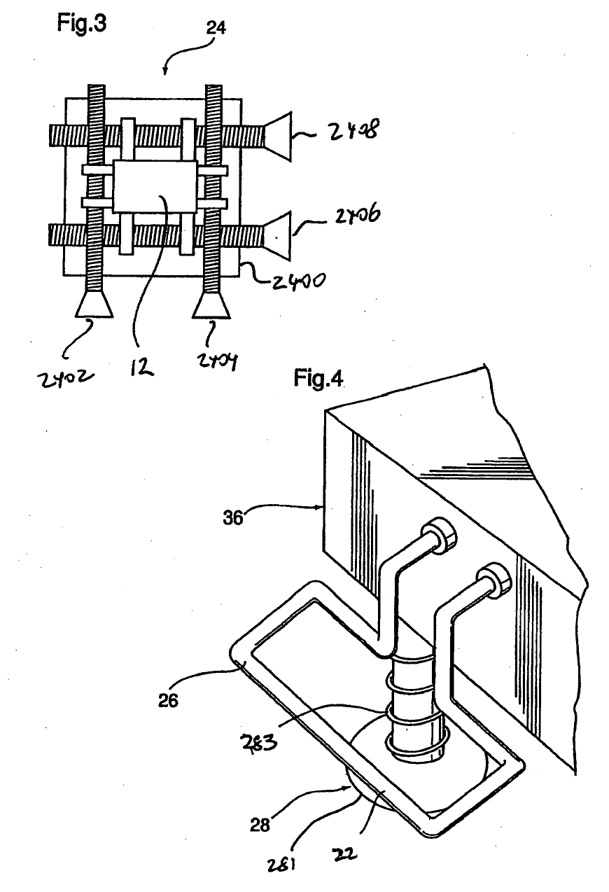

Referring specifically to FIG. 3, for example, the circuit board support 24 is a board positioning fixture configured to facilitate desired positioning of the circuit board's X and Y axes relative to the axial position of the interference shield heating and displacing unit 36. The circuit board support 24 includes a support surface (not shown) configured to support the circuit board 12, which is moveable relative to the base 2400 in response to the adjustable positioning of threaded guide pins 2402, 2404, 2406, 2408 (eg. linear guide screws). Each one of the guide pins 2402, 2404, 2406, 2408 is mounted to the base 2400 and configured to rotate about its respective longitudinal axis. Guide pins 2402, 2404 are positioned such that their respective longitudinal axes are substantially parallel. Guide pins 2406, 2408 are positioned such that their respective longitudinal axes are substantially parallel. Each of the longitudinal axes of guide pins 2402, 2404 are substantially perpendicular to the longitudinal axes of each of guide pins 2406, 2408. Internally threaded collars extend from the support surface and the collars are configured to receive a respective one of the guide pins 2402, 2404, 2406, 2408. While the guide pins extend through the collars, rotation of any one of the guide pins effects displacement of the support surface along the axis of the guide pins being rotated.

In some embodiments, operation of the apparatus 10 is controlled by a controller 54. For example, in those embodiments where the apparatus includes a heating and displacing unit 36, the controller 54 is coupled to the heating and displacing unit 36 (or, optionally, just a heating unit) and is configured to selectively apply a predetermined voltage across the induction heating coil 26 so as to effect generation of a magnetic field by the induction heating coil 26 which, in turn, effects induction heating of the joint 18 between the interference shield 20 and the board component 14. Cooling water flow is supplied as cooling water supply flow 56 to the induction heating coil 26 so as to effect cooling of the induction heating coil 26. The induction heating coil 26 is heated during operation and it is desirable to remove the residual heat so that the induction heating coil 26 does not become overheated. The cooling water supply flow 56 is flowed across the induction heating coil 26 and absorbs heat from the induction heating coil 26, and is then discharged from the induction heating coil 26 as cooling water discharge flow 58. The cooling water discharge flow 58 is disposed at a higher temperature than the cooling water supply flow 56. The cooling water discharge flow 58 is flowed through a heat exchanger 60 so as to effect cooling of the cooling water discharge flow 58. After flowing through the heat exchanger 60, the cooling water discharge flow 58 is recirculated as the cooling water supply flow 56. The cooling water supply and discharge flows 56, 58 are controlled by the controller 54.

A method of uncoupling the interference shield 20 will now be described with reference to the apparatus embodiment disclosed in FIGS. 1 to 4. The heating and displacing unit 36 is lowered by operation of the manual pull lever 50, and thus changes the condition of the displacer 28 from the other than operating condition (see FIG. 2) to the operative condition (see FIG. 1). In the operative condition, the displacer 28 is coupled to the interference shield 20 by a vacuum generated between the displacer 28 and the interference shield, and the induction heating coil 26 is positioned relatively close (for example, 1 to 5 millimetres) to the joint 18 between the component chosen for removal and the board component 14. The coil 26 is then powered with the induction equipment. Through inductive effects, energy is transferred to the joint 18 between the interference shield 20 and the board component 14 through the magnetic field. The joint 18 then heats due to this applied energy at a rate controlled by the amount of power driving the inductive coil 26. At some point, the temperature of the joint 18 will be sufficiently high to melt the solder of the joint 18 which bonds the interference shield 20 to the board component 14 of the circuit board 12, thus relieving the bonding force between the interference shield 20 and board component 14. The manual pull lever 50 is then operated in reverse, effecting retraction of the heating and displacing unit 36, and thereby effecting separation of the interference shield 20 from the board component 14 and thus effecting removal of the interference shield 20 from the circuit board 12.

Another embodiment of a method of uncoupling the interference shield 20 will now be described with reference to the apparatus embodiment disclosed in FIGS. 5 to 8. With the displacer 28 in the non-operative condition and retracted relative to the support 24, and the circuit board 12 supported on the support 24, and the interference shield 20 disposed in the relatively lower temperature condition, the lever 50 is actuated to effect movement of the displacer 28 towards the supported circuit board 12 by the piston 502, against the force being applied by resilient members 283, 323. In doing so, movement of the piston 502 and the displacer 28 towards the circuit board 12 is guided by guides 287, 325, respectively. When proximity of the displacer 28 to the interference shield 20 is sensed by a first proximity sensor, a first proximity switch is activated to effect a vacuum generator to generate a vacuum between the displacer 28 and the interference shield to effect coupling of the displacer 28 to the interference shield 20. Simultaneous or substantially simultaneous with the activation of the first proximity switch, a second proximity sensor senses the piston 502 in the actuated condition, and a second proximity switch is activated, preventing powering of the induction heating coil 26 of an induction heater 12. Upon the coupling of the displacer 28 to the interference shield 20, the actuating force being applied to the lever 50 is removed, and retraction of the piston 502 from the displacer 28 is effected by the resilient member 323, and the movement associated with its retraction is guided by the guide 327. The retraction of the piston 502 is sensed by the second proximity sensor and effects deactivation of the second proximity switch. With the first proximity switch having been previously activated, deactivation of the second proximity switch effects powering of the induction heating coil 26 of the induction heater 12, but does not interfere with the vacuum generation. The induction heating coil 26 is positioned relatively close (for example, 1 to 5 millimetres) to the joint 18 between the component chosen for removal and the board component 14. Through inductive effects, energy is transferred to the joint 18 between the interference shield 20 and the board component 14 through the magnetic field. The joint 18 then heats due to this applied energy at a rate controlled by the amount of power driving the inductive coil 26. At some point, the temperature of the joint 18 will be sufficiently high to melt the solder of the joint 18 which bonds the interference shield 20 to the board component 14 of the circuit board 12, thus relieving the bonding force between the interference shield 20 and board component 14, and then permitting the biasing force of the resilient member 283 to effect retracting of the displacer 28, thereby effecting separation of the interference shield 20 from the circuit board 12, as the interference shield 20 remains coupled to the displacer 28 owing to the vacuum which continues to be generated. Upon sensing of the retraction of the displacer 28 by the first proximity sensor, the first proximity switch is deactivated. With the second proximity switch having been previously deactivated, deactivation of the first proximity switch effects termination of powering of the induction heating coil 26, and within about a predetermined time interval later (for example, 10 seconds), also effects termination of the vacuum generation, thereby permitting removal of the separated interference shield 20 from the displacer 28. During retraction, movement of the displacer 28 is guided by the guide 287. Both of the guides 287, 327 co-operate so that, at the end of each cycle, the piston 502 and the displacer 28 are aligned with each other such that the piston 502 is able to effect contact engagement with the displacer 28, and urge the displacer 28 into a coupling relationship with the interference shield 20, upon its actuation by the lever 50 at the beginning of the next cycle.

The described apparatus and methods mitigate at least one of the following:
1) Time required—With the induction method, the actual removal can take as little as 3 seconds, including the time required to load/unload the circuit board 12 by the operator the complete cycle time is at maximum 20 seconds. In this respect, overall cycle time is reduced by many orders of magnitude.
2) Undesired stress and damage—Induction facilitates directed application of energy to a very specific area and it also reduces damage to plastic components because the field does not heat plastic thereby improving repair efficiency and effectiveness.
3) Solder Balls—Solder balls form because heat is conducted through the PCB substrate from the can to the underfilled component. Inductive rework is a relatively fast heat application process compared to conventional convective processes (ball grid array rework SRT machine). Since the heat is applied for a short duration, the chances of enough energy being conducted to the underfilled components is lower than conventional methods, thus reducing or eliminating the formation of solder balls.

It will be understood, of course, that modifications can be made to embodiments described herein.

1. A method for uncoupling an interference shield from a circuit board comprising:
providing a circuit board including a surface mounted component and an interference shield configured to provide shielding of the surface mounted component, wherein the interference shield is coupled to the circuit board by a joint;
effecting heating of the joint by induction heating such that the interference shield becomes configured for displacement relative to the circuit board in response to application of a mechanical force.

2. The method as claimed in claim 1, wherein the displacement is removal of the interference shield from the circuit board.

3. The method as claimed in claim 1, further comprising:
effecting displacement of the interference shield relative to the circuit board so as to facilitate replacement of the surface mounted component.

4. The method as claimed in claim 1, further comprising:
separating the interference shield from the circuit board so as to facilitate replacement of the surface mounted component.

5. The method as claimed in claim 1,
wherein the joint includes a relatively lower temperature condition and a relatively higher temperature condition, wherein, while the joint is disposed in the relatively higher temperature condition effected by heating of the joint, wherein the heating of the joint is effected by induction heating, the minimum mechanical force necessary to effect displacement of the interference shield relative to the board component is less than the minimum mechanical force necessary to effect displacement of the interference shield relative to the board component while the joint is disposed in the relatively lower temperature condition.

6. The method as claimed in claim 5,
wherein the induction heating effects heating of the joint such that the joint condition changes from a relatively lower temperature condition to a relatively higher temperature condition.

7. The method as claimed in claim 6,
wherein, while the joint is disposed in the relatively higher temperature condition effected by heating of the joint, wherein the heating of the joint is effected by induction heating, displacement of the interference shield relative to the board component is effected.

8. The method as claimed in claim 6,
wherein, while the joint is disposed in the relatively higher temperature condition effected by heating of the joint, wherein the heating of the joint is effected by induction heating, separation of the interference shield from the board component is effected.

9. An apparatus for uncoupling an interference shield from a board component of a circuit board, comprising:
an induction heater configured to generate a magnetic field when disposed in an operative condition,
a circuit board support configured for supporting a circuit board including a board component, a surface mounted component coupled to the board component, and an interference shield coupled to the board component at a joint, wherein the interference shield is configured to provide shielding of the surface mounted component;
such that, while a circuit board is supported on the circuit board support, and while the induction heater is disposed in the operative condition, the induction heater is configured to effect generation of a magnetic field so as to effect induction heating of the joint between the interference shield and the board component.

10. The apparatus as claimed in claim 9, further comprising:
a displacer configured for coupling to the interference shield of the supported circuit board;
wherein the joint includes a relatively lower temperature condition and a relatively higher temperature condition, wherein, while the joint is disposed in the relatively higher temperature condition, the minimum mechanical force necessary to effect displacement of the interference shield relative to the board component is less than the minimum mechanical force necessary to effect displacement of the interference shield relative to the board component while the joint is disposed in the relatively lower temperature condition;
such that, while a circuit board is supported on the circuit board support, and while the joint between the interference shield and the board component of the supported circuit board is disposed in a relatively higher temperature condition, and the displacer is coupled to the interference shield of the supported circuit board, the displacer is retractable from the circuit board support to thereby effect separation of the interference shield relative to the circuit board support.

11. The apparatus as claimed in claim 10, further comprising:
an actuator coupled to the displacer, wherein, when the displacer is disposed in an other than operative condition, the displacer is moveable by the actuator towards any circuit board supported on the circuit board when the displacer is retracted from the any circuit board supported on the circuit board support, wherein the displacer is disposed in an operative condition when the displacer is coupled to an interference shield;
wherein, while the joint between the interference shield and the board component of the supported circuit board is disposed in a relatively higher temperature condition, and the interference shield displacer is coupled to the interference shield of the supported circuit board, the displacer is retractable by the actuator from the circuit board support to thereby effect separation of the interference shield from the circuit board.

12. The apparatus as claimed in claim 11, wherein, when the displacer is disposed in an other than operative condition, the displacer is moveable by the actuator towards any circuit board supported on the circuit board support from a retracted position relative to the any circuit board.

13. The apparatus as claimed in 10, further comprising a biasing member, wherein the retraction of the displacer is effected by the biasing member.

14. The apparatus as claimed in claim 10, further comprising a vacuum generator, wherein the vacuum generator is configured to effect the coupling between the displacer and the interference shield.

15. An apparatus for uncoupling an interference shield from a shielded component assembly supported on a support, wherein the shielded component assembly includes a component support base, a surface mounted component, and the interference shield, wherein the surface mounted component is coupled to a surface of the component support base, and the interference shield is coupled to the component support base at a joint such that the surface mounted component is at least partially shielded by the interference shield, comprising:
a displacer configured for coupling to the interference, shield;
wherein, when the displacer is coupled to the interference shield and the shielded component assembly is supported on the support, the displacer is biased to retract from the support.

16. The apparatus as claimed in claim 15, further comprising a biasing member;
wherein, when the displacer is coupled to the interference shield and the shielded component assembly is supported on the support, the displacer is biased to retract from the support by the biasing member.

17. The apparatus as claimed in claim 16, wherein the biasing member is a resilient member.

18. The apparatus as claimed in claim 15, further comprising a heater configured to heat the joint;
wherein, when the joint is disposed in a relatively lower temperature condition and the displacer is coupled to the interference shield of the shielded component assembly supported on the support, and the joint is heated to, or above, the relatively higher temperature condition by the heater, the biasing of the displacer effects retraction of the displacer relative to the support and thereby effects separation of the interference shield from the base.

19. The apparatus as claimed in claim 15, further comprising a vacuum generator configured to generate a vacuum between the displacer and the interference shield;
wherein the coupling between the displacer and the interference shield is effected by the vacuum generator.
